(19) United States
(12) Patent Application Publication
(10) Pub. No.: US 2009/0044235 A1
(43) Pub. Date: Feb. 12, 2009

(54) METHOD AND SYSTEM FOR ON-LINE CONTENT ACQUISITION AND DISTRIBUTION

(76) Inventor: Daniel L. Davidson, Miami Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 12/186,213

(22) Filed: Aug. 5, 2008

Related U.S. Application Data
(60) Provisional application No. 60/954,484, filed on Aug. 7, 2007.
(60) Provisional application No. 60/985,326, filed on Nov. 5, 2007.

(51) Int. Cl. H04N 7/173

(52) U.S. Cl. 725/87; 725/86

(57) ABSTRACT

A method and system for capturing and distributing electronic media content over a communications network. One or more subscribers capture media about a specific event with the use of a media capture device such as the camera of a mobile phone. The subscriber contacts a central repository and transmits the media content to the repository where the content can be stored, indexed and categorized. The content can be made available to one or more interested third party subscribers such as, for example, news agencies seeking information about the event. A bidding system can be implemented to allow the agency with the highest bid to receive access to the desired content. In return, the subscriber that submitted the content can receive compensation for the submitted content.

### CROSS-REFERENCE TO RELATED APPLICATION

This application related to and claims priority to U.S. Provisional Ser. No. 60/954,484, filed Aug. 7, 2007, entitled METHOD AND SYSTEM FOR ON-LINE CONTENT ACQUISITION AND DISTRIBUTION and U.S. Provisional Ser. No. 60/985,326, filed Nov. 5, 2007, entitled METHOD AND SYSTEM FOR ON-LINE CONTENT ACQUISITION, VALUATION AND DISTRIBUTION, the entirety of each is incorporated herein by reference.

### STATEMENT REGARDING FEDERALLY SPONSORED RESEARCH OR DEVELOPMENT

n/a

### FIELD OF THE INVENTION

The present invention relates to a method and system for aggregating and distributing electronic media, and in particular to a method and system for capturing electronic media related to newsworthy events, uploading the media to a central repository where the media is made available to third parties, sorting and categorizing the media to facilitate third party inquires, and providing a revenue model for the aggregation and sale of the electronic media.

### BACKGROUND OF THE INVENTION

The Internet has become the most widely accepted mechanism for file and information sharing. The Internet's accessibility and affordability have allowed individuals of all backgrounds to share electronic media content. Further, this accessibility and affordability continues to improve. Simultaneously, advancements in electronic devices have allowed many of these individuals to generate more and more electronic media. Because of the portability of electronic devices such as cell phones and digital cameras, individuals are readily equipped to capture images, video, and sound. Moreover, the quality of such content has improved thereby increasing the use of portable electronic devices.

Interestingly, individuals who have generated or captured electronic media (referred to herein as “originators”) have demonstrated a desire to share their content. This is evident by the rising popularity of such entities as YouTube® and MySpace®. For example, originators can upload their captured images, videos, and sound recordings onto YouTube® for others around the world to view. Often the content shared has little or no monetary value, and is shared with no expectation of receiving compensation. However, some of the shared content does have monetary value.

In particular, news organizations may be interested in some of the content uploaded and shared on sites such as YouTube®. An example of such content may be images for a corresponding news story. Because of the tremendous number of cell phones equipped with image capture capabilities, it is more likely that a person equipped with such an electronic device, rather than a professional news reporter, will be at the scene of a news story when the “action” takes place. Thus, news reporters often miss the valuable “action” images they seek, and instead, are left with the less valuable images of the aftermath. Hence, news organizations are in need of a means to interact with the originators.

While newspapers have seen a decline in distribution and readership, more attention is being shifted to cable, broadcast, internet, blogs, mobile devices and other vehicles for delivery of rich video content. Irrespective of medium, the distribution of content related to news and current events is a multi-billion dollar industry and is here to stay. By all measures the news media is becoming considerably more robust as consumers are growing accustomed to, and expect more from, broadband connections, mobile device access, high resolution images, faster connects, richer data, greater search-ability, and other factors.

The news media is one of the most rapidly evolving e-commerce industries as a result of rapidly advancing mobile technologies—supporting broadcast quality image capture over high speed wireless, e.g. third generation data networks. Unfortunately, the benefits of these changes have not been realized by the broadcasting industry as a whole, due to the absence of a central platform for collection and distribution of this new source of content.

Today, media organizations are required to dispatch expensive electronic news gathering crews (ENG) to breaking news events using expensive camera decks, satellite trucks and costly labor in order to capture time-critical content. Due to cost cutting decisions, news organizations have had to decrease the number of ENG teams in the field, and have become increasingly reliant on third party news feeds and alternative methods of acquiring content.

Traditional news broadcasters are maintaining their profits by also cutting back on the size of their newsrooms, while simultaneously demanding that their ever decreasing pool of reporters produce more with less. Compounding the problem has been the immediate need of newsrooms to make substantial capital investments in converting their internal newsroom computer systems (NRCS) from tape based linear systems to nonlinear digital systems. Overall broadcast journalism today has been focused on disseminating the news, not in collecting it.

As news bureau staffs get smaller, the statistical likelihood of a camera equipped reporting team being at the right place at the right time becomes ever less probable. Therefore, traditional news crews, by the time they reach the event, are forced to broadcast images after the event has occurred. Citizen journalism has changed the face of news dramatically as media giants now become increasingly reliant on the public for low or zero-cost content of the action as compared with the high-cost content of the aftermath.

While individuals with cell phones now number 3.3 billion, and individuals with camera equipped mobile devices continue to displace news crews as the primary first reporters of news events worldwide, there currently exists no enabling infrastructure or central repository to acquire, classify, tag, manage, authenticate, distribute and monetize this rapidly increasing amount of captured content. Therefore, citizen reporters find themselves haphazardly providing content at no cost to local news stations, and with no formal infrastructure in place, they do so with little or no possibility of compensation, protection of digital rights or crediting system.

While individuals today currently have the ability to upload through primitive on-line channels their content at no-cost to individual news organizations, they have missed their true opportunity to maximize the potential value of their contribution. This is because of the limited market exposure of calling one to only a few news organizations, negotiations between the parties, documentation of agreements to assign the content, negotiations between the parties, documentation of agreements to assign the content, the delay of delivery of time sensitive content, and having no business entity capable of maximizing content value through a content distribution network.

Further, there is currently no method for the news organizations to easily locate the originators and exchange media or information. Rather, the originators have to contact each news organization separately to offer or sell their content. This process is time-consuming and many originators are not aware of how to contact potential buyers. Social networking sites and repositories lime YouTube® do not offer a solution to these problems. These sites do not provide a means for the originator to receive compensation for sharing content. Furthermore, these sites do not organize content in a manner that is easy for news organizations to analyze. For example, YouTube® does not organize content by region, so that a local television station can find content relevant to its region.

Another deficiency of these sites is that there is no efficient means for an originator to transfer media directly from a portable electronic device in a manner that is financially beneficial to the originator. Currently, originators first transfer their content to personal computers before uploading the content to YouTube® and similar centralized systems. This process is not only inconvenient, but also may reduce the value of the content. Today's society favors the most immediate information, and thus, the sooner the information can reach the consumer the more valuable that information becomes.

It is therefore desirable to have a system and method that allows a content originator the opportunity to offer captured content for sale to interested purchasers in a manner that expediently connects the originator with the prospective purchaser.

### SUMMARY OF THE INVENTION

The present invention advantageously provides a method and system for capturing and distributing electronic media content over a communications network. One or more subscribers to a news dissemination system capture media images on their hand-held image capture devices about a specific event in their area. The subscriber can then contact a central repository and transmit the media content to the repository where the content can be stored, indexed and categorized. The content can then be offered to one or more interested third party subscribers such as, for example, news agencies seeking information about the event. A financial compensation system such as, for example, a bidding system, can be implemented to allow an interested agency to receive access to the desired content. In return, the subscriber that submitted the content can receive compensation for the submitted content via a pre-designated compensation plan.

In one embodiment, a content distribution system for receiving electronic media content captured by an originator's content capturing device and distributing the electronic media to one or more third parties over a network is provided. The system includes a central repository in electronic communication with one or more content capturing devices and one or more third parties over the network. The central repository includes a content repository for receiving and storing content received over the network from the one or more content capturing devices, a processor for determining if the received content is to be distributed to the one or more third parties in return for compensation, where the processor calculates the compensation based upon at least one desired compensation parameter received from the originator, and a distribution module for distributing the content to the one or more third parties in return for compensation.

In another embodiment of the invention, a method for receiving electronic media content captured by an originator's content capturing device and distributing the electronic media to one or more third parties over a network is provided. The method includes receiving the captured electronic media content from content capture device, determining if the received content is to be distributed to the one or more third parties in return for compensation, calculating the compensation based upon at least one originator-established compensation parameter, and distributing, over the network, the content to the one or more third parties in return for compensation.

In yet another embodiment, a method for disseminating media content captured by one or more content capture devices to one or more third parties over a communications network is provided. The method includes enrolling one or more subscribers and one or more third parties, where each subscriber has a content capture device, receiving the captured content from one or more content capture devices, presenting the content to the one or more third parties, receiving requests for the content from the one or more third parties, distributing the content to at least one selected third party, and arranging for the subscriber that submitted the captured content to receive compensation, the compensation being determined based upon at least one desired compensation parameter.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram illustrating an exemplary embodiment of an on-line distribution system constructed in accordance with the principles of the present invention;

FIG. 2 is a diagram illustrating the interaction between originators, a central repository, consumers and enterprise organizations in accordance with the principles of the present invention;

FIG. 3 is a block diagram illustrating the components of the present invention including image capture and image categorization modules;

FIG. 4 is a flowchart illustrating an image capture process in accordance with the principles of the present invention;

FIG. 5 is a flowchart illustrating an image categorization process in accordance with the principles of the present invention; and

FIG. 6 is a diagram illustrating the result of an exemplary third party query for specific newsworthy information in accordance with the principles of the present invention.

### DETAILED DESCRIPTION OF THE INVENTION

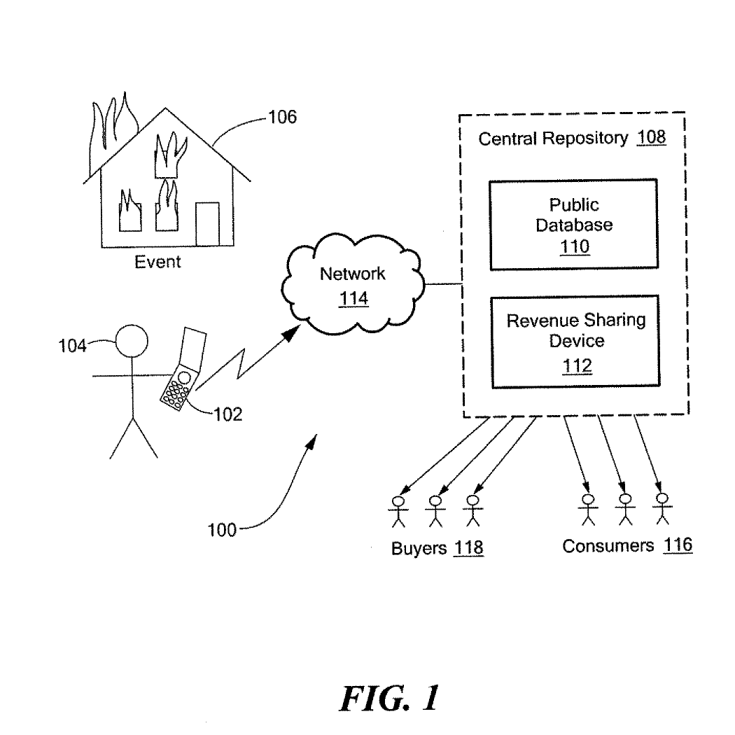

Referring now to the drawing figures in which like reference designators refer to like elements, there is shown in FIG. 1 a diagram of an exemplary system constructed in accordance with the principles of the present invention and designated generally as “100”. On-line distribution system 100 provides for the distribution of electronic media captured by individuals using a portable electronic device 102. Electronic media, such as images, video, sound recordings, etc. are captured by individuals using portable electronic devices, such as cell phones, digital cameras, video cameras, etc. Individuals capturing such media are herein interchangeably referred to as “originators” or “subscribers” 104.

In one embodiment of the present invention, system 100 contemplates the use of a dedicated mobile device 102 that works seamlessly within system 100 to facilitate the capture and uploading of content to a central repository 108. This device would be similar to a mobile phone with a camera but would have higher quality image capture device, audio capture device, built in system for rapid tagging of content, GPS to provide (exact) location and orientation of device (vector to magnetic dipole—ex. 45 degrees North East) and other data pertinent to an event 106 (which could have application in crime forensics, weather forecasting, etc.) and to help provide proof of authenticity and verifiability of location, date, and other variables.

Originators 104 can capture still images, video, audio, or some combination of all three. The captured content could be, for example, a crime such as a bank robbery or a drug deal, a sporting event, the sighting of a famous actress, politician, or athlete, traffic at a certain location, the witnessing of a catastrophic event such as a hurricane or tsunami, or an event of national interest such as a State of the Union address or a space shuttle launch.

Originators 104 may upload their electronic media to a central repository 108 accessible via network 114, for example a cellular communication network, or the Internet. Additionally, originators 104 have the option of making the uploaded electronic media free to the public or to submit the electronic media to a revenue sharing device 112. If the originator 104 chooses to submit the electronic data to the revenue sharing device 112, then the electronic media can be made available to potential buyers through one or more purchase methods, discussed below. If the electronic media is purchased, the originator 104 may receive compensation for the purchased media via one or more compensation plans, also discussed below.

Thus, the present invention includes a method for on-line distribution of newsworthy media content. The method includes a capturing step, an uploading step, and a distribution step. The capturing step is the step in which an originator 104 captures electronic media using a portable electronic device 102. It is understood that the electronic media is captured by operating the portable electronic device 102 in its intended manner. Thus, the details on how to capture electronic media are beyond the scope of the present invention and are not discussed herein.

The uploading step is the step in which the originator 104 uploads the captured electronic media from the portable electronic device 102 to a central repository 108. This uploading step begins when an originator 104 selects the electronic media desired to be uploaded. The originator 104 then enters the appropriate commands, designed for the portable electronic device 102 in use, so that the electronic media is uploaded. Depending on the electronic device 102 the upload commands may be made by pressing one or more buttons.

The distribution step is the step in which the electronic media is made accessible to a buyer 118 and/or consumer 116. The events of the distribution step depend on whether originator 104 requests compensation for the provided electronic media. If the originator 104 does not intend to be compensated, then the distribution step includes placing the electronic media on the network server of repository 108, such that it is accessible to the public. Thus, a consumer 116 may view and/or download the electronic media by opening a web browser, navigating to a designated website, and selecting the desired electronic media. However, if originator 104 desires to be compensated, then the distribution step involves downloading the electronic media from the central repository 108 to a buyer 118 or making the electronic media available to buyer 118. Note, that this downloading may be initiated by the buyer 118 or revenue sharing device 112 of repository 108. In an exemplary distribution step, the revenue sharing device 112 automatically forwards electronic media to news organizations 118 it believes have an interest in the electronic media. Different originator compensation schemes contemplated by system 100 of the present invention are discussed in greater detail below.

Referring to FIG. 1, an on-line media distribution system 100 includes at least one originator 104 with a portable electronic device 102 to record an event 106. A central repository 108 having a public database 110 and a revenue sharing device 112, receive electronic media content over a wired or wireless communications network 114. At least one portable electronic device 102 is coupled to the central repository 108 via network 114, such as the Internet or a telecommunications network (i.e. cellular phone network). It is over this network 114 that electronic media is transferred from the portable electronic device 102 to the central repository 108. The central repository 108 is a database located on a network server, such that it is accessible to third parties via a communication network such as the Internet.

Portable electronic device 102 may be a cell phone, digital camera, video camera, or any portable device capable of capturing electronic media such as images, video, sound recordings, etc. In one embodiment, a portable electronic device 102 has at least one button that originator 104 can press to automatically upload electronic media to the central repository 108. For example, it is contemplated that the portable electronic device 102 can be configured with a dedicated button and include programmatic code to allow the portable electronic device 102 to establish a connection with the central repository 108, transfer the electronic media, etc.

In alternate embodiments, the upload can be performed by any input given by the originator 104. For example, an originator 104 may give a voice command or touch a touch-screen to trigger the portable electronic device 102 to upload the captured electronic media. Additionally, the portable electronic device 104 may include other buttons for allowing the originator 104 to input a sale offer, provide comments about the event 106, or to communicate with repository 108 or other third parties. Such buttons may be found in the form of a keypad or touch screen.

Central repository 108 includes processors, memory devices, data storage devices, I/O devices and communication interfaces, along with the necessary software to enable repository 108 to communicate with originators 104 and third party entities over a communication network, receive images and data from image capture devices 108, index these images and present the images to interested third parties on a website where they are accessible over the Internet. Central repository 108 may be controlled by a system administrator that receives subscriptions to system 100 from customers wishing to enjoy the benefits of the news dissemination system of the present invention.

As mentioned above, the central repository 108 is a database located on a network server. In one embodiment, the central repository 108 is located on a single network server. Alternatively, the central repository 108 may be divided such that it is located on more than one network server. For example, the central repository 108 may be constructed such that its public database 110 is on one network server and its revenue sharing device 112 is on another network server. Among the functions of the central repository 108 are to receive and parse the incoming electronic media, store and categorize the media, and determine whether the incoming electronic media should be stored on the public database 110 or sent to the revenue sharing device 112. This decision to categorize media into public database 110 (where no compensation is sought) or revenue sharing device 112 may be based on the request of originator 104.

If originator 104 decides to share the electronic media with the public for free, then the central repository 108 will forward the data to the public database 110. The public database 110 is a storage medium located on a network server that is globally accessible to the general public via the Internet. The public database 110 also contains a user interface to allow consumers 116 to search and view the electronic media without charge. In an exemplary embodiment, the user interface provides one or more web pages at a designated website. A consumer 116 may access the electronic media by opening a web browser and navigating to the designated website. Once at the website, a consumer 116 may utilize various tools, such as keyword searches, to locate desired media.

Referring to FIG. 1, a sequence of events utilizing the present invention may occur as follows: An event 106 occurs that is captured by an originator 104 on the originator's electronic image capture device 102. Event 106 can be any witnessed, heard or sensed event such as, for example, a fire, a burglary, an earthquake, a hurricane, the sighting of a famous athlete or movie star, or the witnessing of a car accident. The originator 104 can then upload the media content from his or her media capture device 102 to central repository 110 via network 114. Once updated, the content can be disseminated to consumers 116 via access to the Internet, or can be disseminated to one or more news agencies, or buyers 118, via an electronic bidding system. If purchased by or licensed to a news organization 118, the originator 104 may be reimbursed by one of a variety of reimbursement plans (discussed in greater detail below).

As another embodiment, an originator 104 who uploads electronic media to public database 110 may agree to transfer ownership of the uploaded media or to license the media to the service provider of the public database 110 such that the service provider can sell or otherwise distribute the electronic media to generate revenue. This revenue may or may not be shared with the originator 104 depending upon the subscription terms.

Thus, utilizing the camera in the originator's image capture device 102, which can be configured with an internal location traction (GPS or cell site triangulation) mechanism, news organizations 118 can issue specific requests for information at certain geographic locations. These specific requests, referred to as BOLO (“Be-On-Look-Out”) requests, can be narrowed to the smallest subgroup possible through the use of user data profile based on geographic territory (zip code, city, etc.), social interests, sports, or other parameters. For example, when an originator 104 registers with repository 108, information about the originator 104 including their work and home address, and alternate addresses such as summer or winter home, is stored in repository 108. News agencies 118 seeking timely news about an event in a specific geographic region can contact repository 108, and, in turn, repository 108 can quickly determine which originators 104 live or work in the requested region. Alternately, repository 108 can receive GPS signals from all registered electronic devices 114 in the requested region. This information will of course be valuable to the requesting news agency 118 if it needs to obtain information quickly about a newsworthy even happening in a specific region.

In one embodiment, the potential buyers 118 may be buyers previously registered with system 100, such that they have an account with system 100 that allows for efficient sales transactions. Additionally, registered buyers 118 may be sent electronic media of particular interest to them. For example, if the registered buyer 118 is a San Francisco area news organization, then the revenue sharing device 112 may determine which electronic media is relevant to San Francisco and notify the registered buyer 118. The notification may be performed by forwarding the relevant media or alerting the registered buyer 118 of the content via an email, text message, phone call, etc.

The process of filtering the electronic media for relevant content and notifying registered buyers 118 is performed by a computer processor included in repository 108. This processor may utilize keyword searches, sound recognition, and metadata (e.g., cell phone number) to filter the electronic media into groups. By filtering the electronic media into smaller groups, revenue sharing device 112 can efficiently determine which media is relevant to buyers 118. In other words, the filtering process reduces the amount of time a registered buyer 118 needs to sift through electronic media.

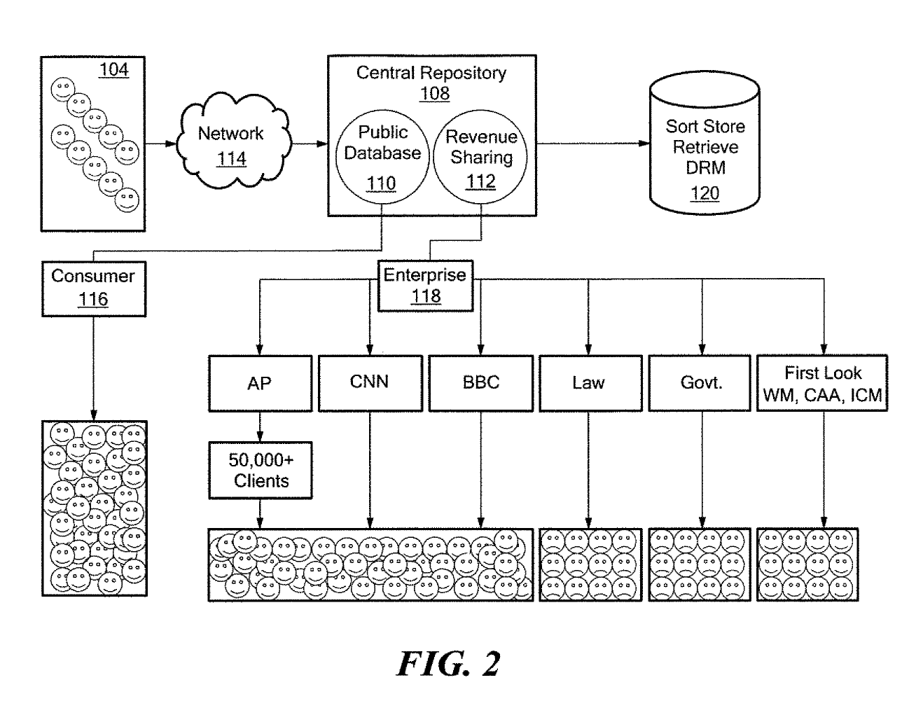

FIG. 2 illustrates the online media distribution system 100 of FIG. 1 in greater detail. One or more content originators 104 may subscribe to a service whereby they can capture electronic media content, upload the media content to central repository 108, and in some instances, be reimbursed for media content captured on their media capture devices 102. Originators 104 can inform repository 108 whether their captured content should be distributed to consumers 116 without compensation to the originator 104 or whether the captured content is to be distributed to one or more news enterprises 118 in return for compensation. If the former, than the uploaded content can be stored in public database 110, if the latter, the content is stored in revenue sharing database 112. In addition to being stored, content in each database can be searched, sorted, retrieved and distributed.

Content in repository 108 can reside in a database 120, where it can be sorted using conventional data sorting algorithms. Enterprise entities 118, which could be, for example, news agencies such as AP, CNN, or BBC, or any commercial, law or government-related agency, can access database 120 in order to search for and obtain news-related media.

In one embodiment of the invention, system 100 allows enterprise entities 118 that have registered with system 100 to directly contact or “ping” originators 104 in order to request content on specific events or focused subject matter, rather than wait for the media content to become available on repository 108. This feature may include a compensation plan that allows originators 104 to receive compensation either directly from the requesting enterprise 118 or indirectly, through repository 108. As an example, enterprise 118 desires information about the sighting of a famous movie star leaving a trendy club in South Beach. Using a location determination mechanism such as Global Positioning System (GPS) or the use of cell site triangulation, the requesting enterprise 118 can receive positioning signals from one or more media capture devices 102 held by originators 104 that are situated within a geographic area near the club. Alternately, enterprise 118 can receive, from repository 108, a listing of data profile information about originators 104, including, for example, each originator's home address, work address, and interests. Using this data, requesting enterprise 118 can then narrow to the smallest subgroup possible the number of available media capture devices 102.

In another example, enterprise 118 may want a “scoop” on the latest happenings at Yankee Stadium in a big game with the Red Sox. By accessing the data profile information about registered originators 104, enterprise 118 can determine which originators are baseball fans, specifically Yankee fans, and live within a certain radius of Yankee stadium. They can then send out text messages to all identified originators, and await media from those originators 104 that choose to upload their captured media content. Thus, system 100 advantageously provides for the interaction between subscribing originators 104 and third party requesting enterprises 118 to allow for the almost-instantaneous and seamless dissemination of real-time media content from an originator's cell phone to media organizations throughout the world.

Of course, system 100 can also be applied to catastrophic or life-threatening events. Obtaining information about a missing child, hurricane, or repeated car accidents occurring at an intersection due to a faulty traffic signal have their obvious benefits. System 100 can provide originators 104 with incentive plans upon joining the system, in the form of, for example, monetary compensation, thus encouraging originators 104 to supply media content to repository 108. In addition, the public at large gains the benefit of an increase in the amount of important real-time events that might not otherwise be captured.

One feature of system 100 is a media content categorization system that allows content to be identified and categorized in order to provide maximum benefit to customers that seek quality news content in a timely manner. Customers can be identified as any third parties, whether news agencies or individuals that subscribe to news-distribution system 100 and that seek media content. Identifying content that is likely to be of high public importance is an important consideration for a news-distribution system. News items must be delivered quickly to maximize value to all subscribers of system 100. System 100 allows customers to identify incoming images of interest immediately following successful image upload of images from the originator's media capture device 102, improving upon the archaic system that historically has required many hours to locate stories of interest, send film crews to the site of the event, and transmit images back to the newsroom for subsequent editing prior to broadcasting of a news story about the event 106.

To achieve this objective, system 100 coordinates the delivery of images that have already been accurately characterized by the time they are presented to a newsroom for search. One method of characterizing images is through metadata population, wherein the subject of a given image is described either prior to upload or immediately afterwards. System 100 contemplates image metadata being created and/or edited from three different perspectives, including by originator 104, by repository 108 via manual or automatic metadata imaging, and a by a customer of system 100, as a refinement technique prior to image selection and playout. This arrangement advantageously delivers an accurate image search to the system customer as quickly as possible, with the least amount of post-upload effort invested by the customer.

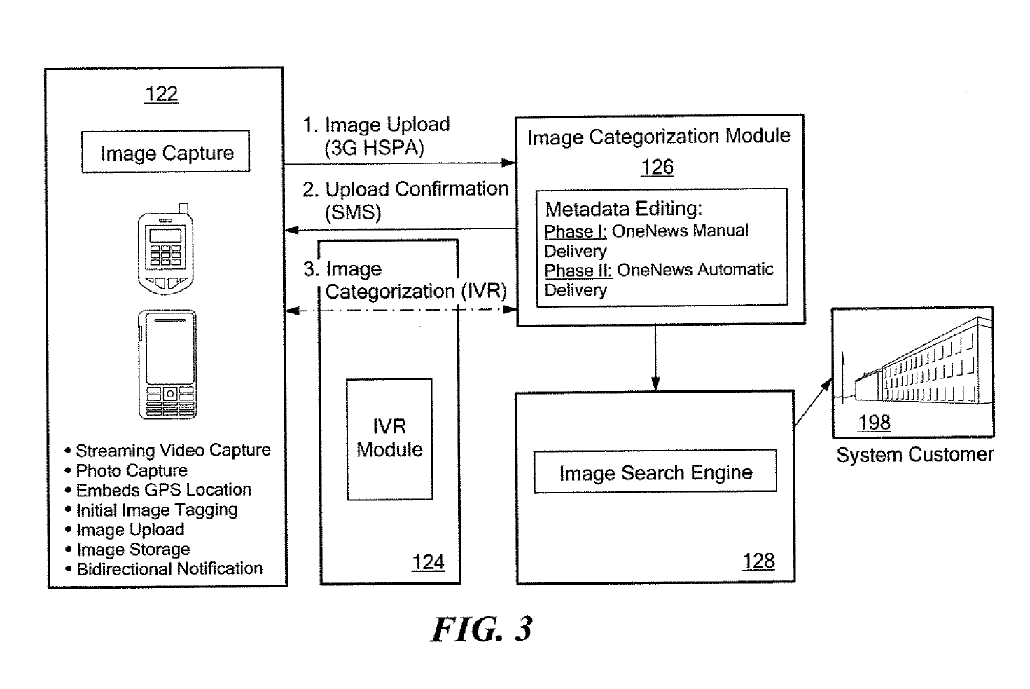

FIG. 3 illustrates an example of interactive modules used in the on-line media distribution system 100 of the present invention. System 100 includes Image Capture Module 122, IVR Module 124, Image Categorization Module 126, and Image Search Engine 128. Image Capture Module 122, which resides on image capture device 102 includes the hardware, software, and interface modules to allow an originator's image capture device 102 (i.e., a cellular phone), to capture image content, upload that content to repository 108 or third parties via any standard mobile telephony protocol such as High Speed Packet Access (HSPA), receive and transmit messages to repository 108 or third parties, and store all or portions of the content on the image capture device 102.

Module 122 captures image content of an event 106, where the “image” could be a photograph of the event 106, and/or audio or video of the event 106. Image Capture Module 122 allows the originator 104 to perform initial image tagging using a news exchange standard such as for example, EventsML-G2-compliant metadata descriptors. Image capture device 102 may also be enabled to store the captured image in the event that cellular infrastructure is unable to transmit the image to the repository 108 streaming due to, for example poor cellular signal or crimped bandwidth due to cellular tower overload. This allows originator 104 to store the image content for delivery at a later time.

Image capture devices 102 that are equipped with GPS transmitters can geocode captured images enabling image authentication and real time originator location information to be transmitted to repository 108. Time stamp, date stamp and GPS or cell-site triangulation information can be received by repository 108 or third party enterprise organizations 118 along with the images and correlated with the images to provide time, date and location of event 106. Confirmation that the image was received by repository 108 can be sent back to the originator's image capture device 102 via any standard communication protocol such as, for example, the Short Message Service (SMS) protocol. Image Capture Module 122 may also include software to allow for the receipt of third party text messages, i.e., “pings”, from enterprises 118 wishing to inform certain originators 104 about real-time activities occurring in their geographic locations that may require additional coverage in the field, as well as for the transmission of messages to the sending party.

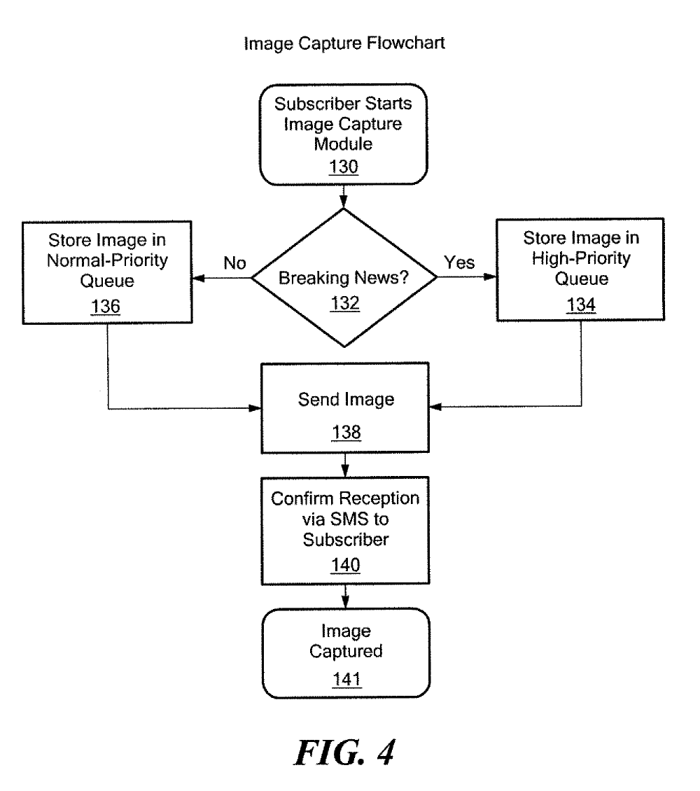

FIG. 4 is a flowchart illustrating an exemplary communication between an originator or subscriber 104 and repository 108 when images are captured on the originator's image capture device 102 and are to be transmitted to repository 108. Via step 130, an originator 104 that has subscribed to the on-line media distribution system 100 of the present invention captures an image of an event 106 utilizing Image Capture Module 122 residing in the originator's media capture device 102. Depending upon the availability of cellular service in the area, the image can be temporarily stored on image capture device 102 and then sent to repository 108, or, if network 114 is operating, immediately upload the captured media to repository 108.

Via step 132, a dialogue box presented to the originator 104 on his or her image capture device 102 prior to image transmission, requests the originator 104 to identify whether the image should be categorized as “Breaking News”. The definition of what constitutes “Breaking News” is arbitrary and predefined and communicated to each originator 104 upon subscribing to system 100. If the image qualifies as “Breaking News”, a copy of the image is moved, via step 134, to a high-priority processing queue in repository 108 after it has been transmitted to the repository 108. If it does not qualify as “Breaking News”, then, via step 136, a copy of the image is stored in a normal-priority queue in repository 108 once it has been transmitted there. Via step 138, the image is transmitted from device 102 to repository 108.

It is within the scope of the present invention to first transmit the image from device 102 to repository 108 via step 138, and once the image arrives in repository 108, to then determine if the image qualifies as “Breaking News” or not. The determination of whether or not media content qualifies as “Breaking News” or any other threshold level of news, can be based on information relayed to repository 108 from originator 104 along with the uploaded media content, and/or input from other originators 104 (for example, many uploaded images or content from other originators 104 in the same geographical location might reinforce the importance of the event 106). Once the image is transmitted to repository via step 138, an Upload Confirmation may be sent, via step 140, from repository 108 to the subscriber via, for example, an SMS delivery, to confirm that the image that was captured by device 102 has been received by repository 108, at step 141.

Referring again to FIG. 3, IVR (Interactive Voice Response) Module 124 and Image Categorization Module 126, each residing within repository 108, form an interactive mechanism to allow for the categorization of media content. The captured image will be initially categorized by the subscriber 104 using one of a number of techniques according to the principles of the present invention. One image categorization technique offered to subscriber 104 is an IVR Dialogue Module, while another is a Web-Based Entry. In one embodiment, the IVR Dialogue technique is offered as the default choice unless otherwise identified by subscriber 104. As part of the initial program start, Image Capture Module 122 will interrogate subscriber 104 as to image categorization preference.

Both the Web-Based Entry and IVR Dialogue approaches involve the subscriber 104 completing two distinct activities. First, the subscriber 104 will be asked to navigate through a series of questions designed to quickly place the image into one of a plurality of subjects. These subjects could be randomly generated or be subjects designated by the International Press Telecommunications Council Subject Reference System (IPTC SRS). Next, subscriber 104 will be asked to describe event 106. The verbal event transcription will be stored and filtered through repository's Audio-to-Text translation module, allowing the text description to convert into searchable metadata. It should be noted that the quality of the resulting metadata will vary depending on the accent of subscriber 104, connection clarity, coherence of expression and other factors. Finally, Image Capture Module 122 can transmit geocoded images enabling incoming submissions to be geographically located. Between the initial SRS categorization performed by the subscriber 104, the verbal event description, and the GPS location transmitted with the image, a usable categorization can be delivered immediately following image transmission, thus allowing a system customer 198 to be search for and/or be presented with captured content of interest.

IVR Module 124 operates as follows: once an image has been received, repository 108 will index the image (i.e., place it in the appropriate priority queue) and instruct an IVR front-end interface module to contact the originator 104 and walk the originator 104 through a dialogue that assists in categorizing the image. The repository 108 will subsequently expand the image metadata and re-index the image, enabling newsroom search. For example, originator 104 may be presented with an IVR menu that corresponds to the designated IPTC SRS Top-Level Subject categorization and may appear as shown in the menu below. The IVR menu can be constructed to present the most newsworthy categories first on the menu in order to enable quick initial placement by the subscriber. As example is provided as follows:

| | English | |
|---|---|---|
| Top-Level Subject | Abbreviation | Reference Number |
| Arts, Culture and Entertainment | ACE | 010000000 |
| Crime, Law, and Justice | CLJ | 020000000 |
| Disasters and Accidents | DIS | 030000000 |
| Economy, Business, and Finance | FIN | 040000000 |
| Education | EDU | 050000000 |
| Environmental Issues | ENV | 060000000 |
| Health | HTH | 070000000 |
| Human Interest | HUM | 080000000 |
| Labor | LAB | 090000000 |
| Lifestyle and Leisure | LIF | 100000000 |
| Politics | POL | 110000000 |
| Religion and Belief | REL | 120000000 |
| Science and Technology | SCI | 130000000 |
| Social Issues | SOI | 140000000 |
| Sport | SPO | 150000000 |
| Unrest, Conflicts and War | WAR | 160000000 |
| Weather | WEA | 170000000 |

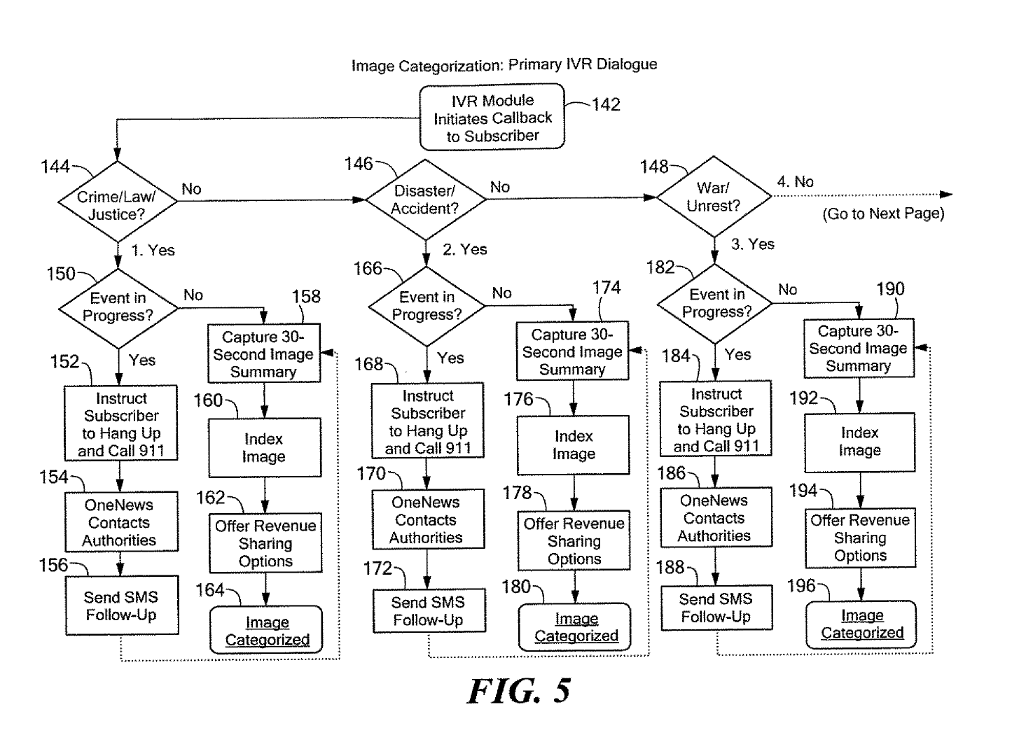

An exemplary IVR dialogue is shown in FIG. 5 and discussed below. Subscriber 104 contacts repository 108 and indicates that they have a captured image of an event. Via step 142, IVR Module 124 contacts subscriber 104. Subscriber 104 is asked to categorize the image into one of the Top-Level Subjects shown in a menu presented to the subscriber 104. For example, via steps 144-148, subscriber 104 is asked if the event is related to a crime or legal matter, a disaster or accident, or a war or matter related to political unrest. Thus, the subscriber 104 is selectively given the opportunity to identify events that may impact public safety and if so identified, the image is flagged at a highest possible priority, and law-enforcement and/or public-safety officials may be notified. For example, if a crime is in the process of being committed, then, via steps 150-156, subscriber 104 is instructed to hang up and contact 911, while repository 108 contacts the appropriate authorities and a follow up message is sent to subscriber 104. If the criminal event has already occurred then, via steps 158-164, the subscriber 104 captures an image of event 106 and it is indexed and categorized accordingly. Similar scenarios can occur if the event is an accident, via steps 166-180, related to war or political unrest, via steps 182-196, or any other categorized subject.

In one embodiment, subscriber 104 is given a fixed amount of time, for example, thirty seconds, to describe event 106. Following the dialogue, this description is stored as audio metadata and can subsequently be filtered through a speech-to-text mechanism having an output that can be also stored as (searchable) text-based metadata. Subscriber 104 can be offered compensation of delivery of the image according to one of a number of revenue sharing plans. Images can be categorized either prior to or after upload from device 102 to repository 108 via network 114 via the use of image metadata. The subscriber 104 may create or edit the metadata, or this could be done by repository 108 via a Metadata Editing Module within Image Categorization Module 126, which can perform editing either manually or via an automated process. Consumer 116 or buyer 118 could also edit the metadata as a refinement technique prior to image selection and playout. Regardless of where the image metadata editing occurs, consumers 116 and buyers 118 will be provided with the ability to accurately search for images with a minimal investment of effort.

In one embodiment of the invention, an Image Quality Management System (“IQMS”) is used as a reputation-based rating system to present search results to customers of system 100. With this approach, images submitted by subscribers 104 are rated by system customers as well as other users of system 100 such as staff members. Over time this enables subscribers 104 who have built a reputation for high-quality images to “rise to the top” of any given search, enabling the system customer base to build a “known-to-be-good” base of reliable originators 104, avoiding situations where system customers are spending inordinate amounts of time trying to determine whether a given event submission should be trusted. Thus, query results displayed at the repository 108 console will default to highlight submissions from subscribers 104 with “known-to-be-good” backgrounds.

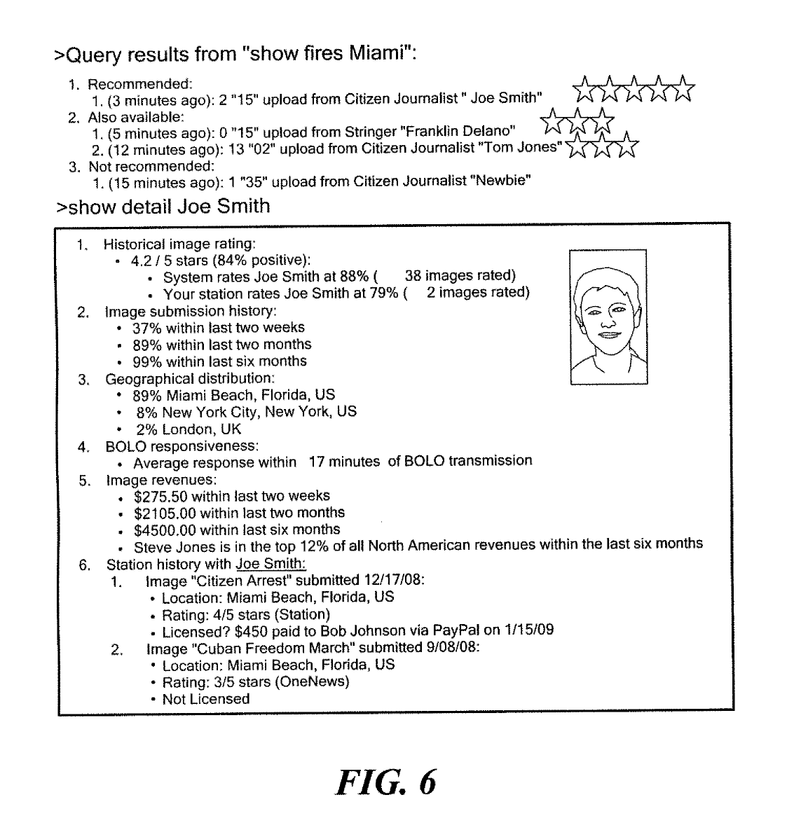

FIG. 6 is an exemplary screen that may be presented to a consumer 116 or buyer 118 of system 100 that would like to find a subscriber 104 knowledgeable about fires occurring in Miami. Based upon this search entry, system 100 presents a screen with a highly recommended subscriber 104, i.e., Joe Smith (with a five star confidence rating), with other subscribers 104, i.e., Franklin Delano, and Tom Jones, listed with a lower confidence rating (three stars). The screen shows how long ago each subscriber 104 uploaded their image and how large the image file is or how long the audio file is. Exemplary criteria used by system 100 to rate each subscriber 104 can been seen in the lower portion of the screen of FIG. 6, which shows detailed information for subscriber Joe Smith.

Referring to FIG. 6, many different criteria for Joe Smith can be viewed. For instance, Smith is given an average historical image rating, i.e., 4.2 out of 5 stars, a system rating based on the timing and quality of previously submitted images, and another rating submitted by the customer 116 or enterprise 118 seeking the information, based upon their past experiences with Joe Smith. Other rating that can be shown are an Image submission history, i.e., the percentage of times Smith submitted an image in response to a third party request, a Geographical distribution summary which shows the geographic location of the events Smith has captured and uploaded, a BOLO responsiveness rating showing how quickly, on the average, Smith responded to a third-party (BOLO) request, the amount of revenue realized by Smith for submitted images, and a summary of Smith's previously submitted images. The screen presented in FIG. 6 is exemplary only, and it is within the scope of system 100 to provide a summary screen with a variety of user and system information and rating criteria.

System 100 allows for the monitoring and control of the quality of content received from the many originators 104 that subscribe to the news system 100. Authenticity of the media content and originator 104 can be assured using one or more of a variety of security techniques including having the originator 104 signing an affidavit attesting to content authenticity, and/or making representations and warranties that the images are true, real and un-doctored, transmitting to repository 108 an Electronic Serial Number (ESN) or an Electronic Identification Number (EIN) with the captured image at the time of upload, or recording the originator's voice to obtain a digital voice stamp for further security. Recorded data can include time, date, location, event description, observations, contact information and a recorded verbal affidavit of truthful disclosure

Repository 108, upon receipt of many uploaded images, can, with the use of its processor and related software applications, depict news information in a graphic presentation thus allowing for the rapid analysis of news “clusters” based on proprietary algorithms incorporating a variety of parameters. In addition to clustering relevant data, another part of the graphic depiction can provide velocity, acceleration and vector analysis of the inbound information. For example, in the event of either a forest fire or civil unrest, the rate of uploaded information and the vector depicted on a map may help depict trends in real time and assist law enforcement and/or other agencies in assessing the threat and addressing the issue. Thus, the present invention can advantageously be used to assist organizations outside the news agency arena.

As discussed above, repository 108 is able to record the time stamp, date stamp, and GPS signal of the uploaded data transmission. As an example of the applicability of the present invention to other agencies, repository 108 can correlate the time-stamped, data-stamped and GPS information with a global weather database and store that information for future reference. The use of GPS information can also assure the authenticity of the originator's content. For example, consider a situation where originator 104 claims to have witnessed a bank robbery at “the corner of First and Main” when in fact they stated the image at a different location in order to fool news organizations and collect a fee for the sale of the image of the staged event. System 100 would be able, through received time-stamped meta-tags and GPS information, to determine if originator 104 was indeed at the corner of First and Main at the time the image was uploaded to repository 108.

Another example of the far-reaching applicability of the present invention is the use of system 100 in the legal arena. The analytical tools provided by system 100 provides for the rapid assessment and correlation of data that might otherwise go unnoticed. For example, attorneys might use the service to assist in legal cases where car accidents occur repeatedly at an intersection. While each individual event, taken alone, may constitute “only” a car accident, the aggregate of information regarding multiple car accidents at the same intersection could be of great interest. System 100 would be able to provide video, still photographs and audio/text information about each event and could be used in court as evidentiary information. This information further correlated with time stamp, date stamp and weather information may show, for example, that when it rains and the temperature falls below, for example, 55 degrees the streetlight at a particular intersection fails to operate, therefore resulting in one or more serious injuries or fatalities at the intersection of interest.

System 100 could provide law enforcement agencies with a comprehensive set of data related to, for example, suspicious persons, events, missing children, etc. Thus, law enforcement agencies will have, at their service, potentially hundreds of millions of “officers” worldwide, providing a powerful asset to all law enforcement agencies that take advantage of system 100. Repository 108 can transmit the video images live directly to law enforcement agencies, therefore enhancing to the current scenario in which a verbal description of a perpetrator (e.g., medium height, olive skin, red shirt) is replaced with an actual image of the perpetrator holding up the bank, or involved in a terrorist activity. Therefore, in one embodiment, system 100 allows for images of a current event to be transmitted from a user's mobile phone in real time to a central repository 108, and from there directly to a law enforcement dispatch/operator who in turn transmits the image to the computer screen of the responding officer's patrol car.

As discussed above, originator 104 can choose to upload media content for return compensation. If originator 104 decides he or she wants compensation for the uploaded electronic media, then the central repository 108 forwards the electronic media to the revenue sharing device 112. In one embodiment, originator 104 also sends a compensation parameter, or value indicator along with the electronic media. The value indicator may be a dollar amount, percentage, or a numerical factor. Furthermore, the value indicator may represent the originator's perceived value of the electronic media, a minimum amount the originator 104 is willing to accept as compensation for the electronic media, or a portion of the final sale price.

When the revenue sharing device 112 receives the electronic media, it stores it into computer memory such that at least a portion is accessible to potential buyers 118. If a buyer 118 purchases the media content, a number of payment options are available. These payment options include, but are not limited to, transferring payment to the bank account belonging to the operator of the central repository 108, paying by credit card, or having the operator of the central repository 108 mail an invoice to the buyer 118. Notably, it is advantageous to the buyer 118 to have a centralized supplier (i.e. the operator of the central repository 108) for the purpose of making efficient and convenient payments.

Content stored in revenue sharing database 112 can be made available to news agencies 118 via a number of different ways. In one embodiment, a fixed-price system will post content at a specific price, and third parties may purchase or license the offered content. In another embodiment, repository 108 establishes a bidding system whereby agencies 118 enter their bids for specific content. For example, when a newsworthy event 106 occurs (fire, tornado, bank robbery, etc . . . ), originator 104 captures the event 106 with his/her mobile device 102. Originator 104, having previously subscribed to system 100, can be equipped with an image capture device 102 that is specifically enabled to allow originator 104 to seamlessly capture and upload media content to repository 108, via, in one embodiment, a “one-touch” button that allows the originator 104 to upload content directly to repository 108 directly from their media capture device 102. Originator 104 may also be given the option to transfer their media to their personal computer and to transmit the image directly from their computer to repository 108 via the Internet. Thus, with the press of a button, the captured image can be uploaded to content repository 108.

News organizations 118 can bid for content made available on the Internet by repository 108. For example, system 100 can post on their website images about a specific news event. News Organizations 118 submit bids for the content and a winning bidder is identified. When an agreed-upon-price by the parties is reached, monies can be transferred from the News Organization 118 to repository 108 (and by repository 108 to originator 104). The media content may then be distributed by organization 118 to certain third parties via specific media channels in an agreed-upon territory for an agreed-upon period of time.

The present invention allows originator 104 to be compensated for the capture and submission of an event 106. A computer processor in the revenue sharing device 112 computes the compensation an originator 104 is to receive from the sale of his/her electronic media. The present invention incorporates a compensation pricing model that can incorporate geographic territory rights, terms of exclusivity, form of media, time constraints, and others factors. When each originator 104 signs up to the news-distribution system 100 of the present invention, they can select a compensation option. Originator 104 can be given the option to pre-purchase up to 100% of the image revenues. A default model can be, for example, that originator 104 will receive 50% of the realized value, or revenue generated from the sale of an uploaded image without paying any fee to repository 108. Originator 104 can be given the option to purchase additional 10% increments at $1 each. For example, a $5 investment will allow subscriber 104 to purchase 100% of the revenue from his or her uploaded image. Thus, each subscriber 104 can receive compensation for their captured images that are uploaded to repository 108 by submitting to repository 108 at least one desired compensation parameter, whether it be a percentage of the ultimate purchase or license fee of the image, a compensation fee dependent upon the newsworthiness of the image, a fee dependent upon the subscriber's perceived value of the image or some other factor.

Other compensation schemes would allow originator 104 to receive a higher percentage for content that is deemed more newsworthy. Thus, originator 104 might be willing to sign up for a compensation plan that requires a higher initial payment for “Breaking News” content, but that would result in a higher payment percentage in return for the uploaded media. Other schemes could include factors such as how quickly originator 104 responds to a BOLO request (the faster the more money received) and the geographic location of originator 104 (sending media from a remote location, far from the originator's home might result in higher compensation).

In other compensation schemes, the computer processor utilizes an algorithm that incorporates a number of parameters. These parameters include but are not limited to perceived value of content (PVOC), actualized value of content (AVOC), distributable revenue (DR), length of exclusivity (LOE), territory rights (TR), media usage (MU), viewer rating value (VRV), uniqueness of content (UOC), percentage of participation (POP), reporter revenue (RR), and other (O).

An exemplary compensation algorithm is: RR=(PVOC*AVOC*DR*POP* (LOE+TR+MU))/UOC. In this algorithm, the PVOC corresponds to the value indicator submitted by the originator 104. The other parameters of the algorithm are generally predetermined or assigned by authorized individuals on a case-by-case basis, however, they may also be provided by originator 104. Additionally, the algorithm and the values associated with the parameters may or may not be available to originators 104 and buyers 118. It may be advantageous to keep the algorithm and its parameters unpublished, so as to keep originators 104 from circumventing the revenue sharing device 112 or from disputing values of the parameters.

Once the appropriate compensation is computed, the revenue sharing device 112 initiates a payment to the originator 104 of the purchased content. This payment may be made in a number of ways including, but not limited to, sending the originator a check, depositing the payment into a registered account, (such as, for example, crediting the cell phone bill), or transferring the payment to the originator's bank account. Furthermore, the manner in which the originator 104 receives payment may be determined by the originator 104 prior to or at the time of uploading the electronic media to the central repository 108.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. A variety of modifications and variations are possible in light of the above teachings without departing from the spirit or essential attributes thereof, and accordingly, reference should be had to the following claims, rather than to the foregoing specification, as indicating the scope of the of the invention. In addition, unless mention was made above to the contrary, it should be noted that all of the accompanying drawings are not to scale.

What is claimed is:

1. A content distribution system for receiving electronic media content captured by an originator's content capturing device and distributing the electronic media to one or more third parties over a network, the system comprising:
a central repository in electronic communication with the content capturing device and the one or more third parties over the network, the central repository including:
a content repository for receiving and storing the electronic media content received over the network from the content capturing device;
a processor for determining if the received content is to be distributed to the one or more third party in return for compensation, the processor calculating the compensation based upon at least one desired compensation parameter received from the originator; and
a distribution module for distributing the content to the one or more third parties in return for the compensation.

2. The system of claim 1, wherein the central repository includes:
a revenue sharing module for presenting the content to the one or more third parties and for receiving offers for the content that is to be distributed for compensation; and
a public database for storing accessible content that does not require compensation for its distribution.

3. The system of claim 1, wherein the processor determines if the received content is to be distributed to one or more third parties by receiving, from the content capturing device, a command requesting compensation for the delivered content.

4. The system of claim 3 wherein the command requesting compensation for delivered content includes the at least one compensation parameter.

5. The system of claim 1, wherein the compensation parameter indicates a perceived value of the delivered content.

6. The system of claim 1, wherein the compensation parameter indicates a minimum compensation amount.

7. The system of claim 1, wherein the compensation parameter indicates a percentage of a realized value of the distributed content.

8. The system of claim 2, wherein the revenue sharing module receives requests from the one or more third parties for specific content and the processor determines which received content corresponds to the received one or more third party requests.

9. The system of claim 8, wherein the revenue sharing module notifies the requesting one or more third parties that a match exists between the request for specific content and received content.

10. The system of claim 1, wherein the central repository receives image categorization criteria in order to categorize, by level of importance, the content.

11. The system of claim 1, wherein the central repository receives geographic location information from the content capturing device, the geographic location information identifying the location of the content capturing device that sent the content.

12. A method for receiving electronic media content captured by an originator's content capturing device and distributing the electronic media to one or more third parties over a network, the system comprising:
receiving the captured electronic media content from the content capturing device;
determining if the received content is to be distributed to the one or more third parties in return for compensation;
calculating the compensation based upon at least one originator-established compensation parameter; and
distributing, over the network, the content to the one or more third parties in return for compensation.

13. The method of claim 12, further comprising:
presenting the content to the one or more third parties;
receiving offers, from the one or more third parties, for the content and
distributing the content to a selected third party.

14. The method of claim 12, further comprising receiving, with the captured content, the at least one compensation parameter.

15. The method of claim 12, wherein the compensation parameter indicates a perceived value of the delivered content.

16. The method of claim 12, wherein the compensation parameter indicates a percentage of a realized value of the distributed content.

17. They method of claim 12, further comprising:
receiving image categorization criteria; and
categorizing the content based on the received image categorization criteria.

18. The method of claim 12, further comprising receiving geographic location information from the content capturing device, the geographic location information identifying the location of the content capturing device that sent the content.

19. A method for disseminating media content captured by one or more content capture devices to one or more third parties over a communications network comprising:
enrolling one or more subscribers and one or more third parties, each subscriber having a content capture device;
receiving the captured content from one or more content capture devices;
presenting the content to the one or more third parties;
receiving requests for the content from the one or more third parties;
distributing the content to at least one selected third party; and
arranging for the subscriber that submitted the captured content to receive compensation, the compensation being determined based upon at least one desired compensation parameter.

20. The method of claim 19, further comprising forwarding a request by an enrolled third party to one or more enrolled subscribers to capture content related to a specific event.
